(19) United States
(12) Patent Application Publication
(10) Pub. No.: US 2004/0089529 A1
(43) Pub. Date: May 13, 2004

(54) Electromotive furniture drive for adjusting furniture parts relative to one another

(76) Inventor: Johannes Schneider, Kirchlengern (DE)

Correspondence Address: Robert W Becker & Associates, Suite B, 707 Highway 66 East, Tijeras, NM, 87059, US

(21) Appl. No.: 10/472,290

(22) PCT Filed: Mar. 15, 2002
(86) PCT No.: PCT/EP02/02927

(30) Foreign Application Priority Data
Mar. 17, 2001 (DE) 10113031.7

(51) Int. Cl. H01H 1/10

(52) U.S. Cl. 200/512

(57) ABSTRACT

The invention relates to an electromotive drive for furniture for adjusting furniture parts in relation to one another. Said drive comprises a hand switch (2) with a housing, on or in which electric switching means are arranged for controlling the drive for furniture. According to the invention, the electric switching means are composed of a first part (8), configured from at least one strip conductor (16), which forms part of a control circuit for controlling the drive for furniture and a second part (10). The first part (8) and the second part (10) are located at a distance from one another and the second part (10) has at least one elastically deformable contact element (38), which consists at least partially of an electrically conductive material and can be displaced between a resting position and an actuating position. In the latter position, electrical contact is made between the strip conductor (16) and the contact element (38) in such a way that the drive for furniture is controlled in the actuating position. The inventive drive for furniture can be simply and therefore cost-effectively produced. For practical purposes the first part (8), the second part (10) and the third part (12) have a film-type configuration. The hand switch can therefore have a small overall height.

The invention relates to an electromotive furniture drive of the type mentioned in the introductory portion of claim 1 for the adjustment of parts of a piece of furniture relative to one another.

Such furniture drives are known in general, for example from DE 195 29 962 C2. For actuation by a user, they have a hand switch that has a housing on which or in which electrical switching means for the control of the furniture drive are arranged. The electrical switching means are part of a control circuit of the furniture drive, so that the furniture drive can be controlled by actuation of switching elements of the hand switch, for example in the form of push buttons. With the known furniture drives, the electrical switching means are formed by microswitches.

A drawback of the known furniture drives is that due to the microswitches they are relatively complex and hence expensive to manufacture.

It is an object of the invention to provide an electromotive furniture drive of the type mentioned in the introductory portion of claim 1, the manufacture of which is simplified and is hence more economical.

This object is realized by the teaching of claim 1.

The invention is dissociated from the idea of forming the electrical switching means by microswitches. Instead, the invention provides a first part and a second part, with the first part having at least one strip conductor and the second part having at least one elastically deformable contact element that is comprised at least partially of an electrically conductive material. The contact element is moveable between a rest position and an actuating position whereby in the actuating position an electrical contact is established between the strip conductor and the contact element in such a way that in the actuating position a control of the furniture drive is effected.

In this way, the use of microswitches is avoided, so that the construction of the inventive furniture drive is simplified and is hence more cost effective.

Since the contact element is elastically deformable, after actuation it springs back into the rest position from the actuating position, so that separate means for returning the contact element to the rest position are not required.

The shape and size of the contact element are freely selectable over a wide range. The contact element is expediently embodied in a tongue-like manner, as provided by one embodiment.

In principle, the contact element can be embodied as a separate component that is connected with the first part. However, pursuant to a particularly advantageous further development, the contact element is monolithically formed with the second part. In this way, manufacture is further simplified since a separate component is not required for the formation of the contact element.

Pursuant to another further development, the first part and/or the second part has an essentially sheet-like or laminar configuration. With this embodiment, due to the essentially sheet-like configuration of the first part and/or the second part, the hand switch has a particularly low overall height.

In principle, it is sufficient if the contact element and the strip conductor be comprised of an electrically conductive material, whereby, however, the first and the second part otherwise comprise an electrically insulating material. However, a particularly advantageous further development provides that the first part and/or the second part be comprised essentially entirely of an electrically conductive material. This further simplifies the manufacture of the inventive hand switch.

Another, extremely advantageous further development of the inventive teaching provides that the first part and/or the second part be embodied in an essentially film-like or sheet-like manner. With this embodiment, the manufacture of the first part and/or of the second part is particularly economical, since due to the sheet-like configuration only very little material is necessary for producing these parts. Furthermore, thin sheets, for example thin metal sheets, can be processed particularly easily, for example by cutting, stamping or etching.

Pursuant to another further development, the first part and the second part are kept spaced from one another by spacer means.

Pursuant to a further development of the aforementioned embodiment, the spacer means comprises an electrically insulating material. In this way, the spacer means simultaneously effect an electrical insulation of the first part relative to the second part, so that in the position of rest of the contact element, an electrical contact is reliably prevented between this component and the strip conductor of the first part.

With the aforementioned embodiment, the electrically insulating material is expediently plastic. This results in a particularly straightforward and hence economical construction.

Pursuant to an extremely advantageous further development of the embodiment with the spacer means, the spacer means is formed by an essentially laminar third part that has an opening through which the contact element extends in the actuating position for contacting the strip conductor of the first part. With this embodiment, the overall height of the hand switch of the furniture drive can be reduced still further, since not only the first and the second part but also the third part have an essentially sheet-like configuration and can be disposed one above the other in a sandwich-like manner.

To enable a control of a plurality of functions of a furniture drive, the second part expediently has at least two contact elements.

A further development of the embodiments with the at least two contact elements and the sheet-like third part provides that an opening in the third part be respectively associated with the contact elements.

To further simplify, and hence make more economical, the manufacture of the first part or of the second part, pursuant to another further development the first part and/or the second part is formed by a stamped part. The material of the first part or of the second part is freely selectable over a wide range. Pursuant to one expedient embodiment, the first part and/or the second part is comprised of phosphor bronze. With this embodiment the first or the second part is particularly economical. Furthermore, phosphor bronze has a high electrical conductivity.

For the control of a plurality of functions of the furniture drive, it is expedient for the first part to have at least two strip conductors that are electrically insulated relative to one another.

Pursuant to another further development, in the actuating position the contact element interconnects two strip conductors that are associated with the first part in an electrically conductive manner. In this embodiment, in the actuating position of the contact element a control current for the furniture drive flows over two strip conductors of the first part that are interconnect by the contact element in an electrically conductive manner.

Pursuant to another expedient embodiment, in the actuating position the contact element connects one strip conductor associated with the first part with a strip conductor that is associated with the second part, and that is electrically conductively connected with the contact element in an electrically conductive manner. With this embodiment, a control current for the control of the furniture drive flows from the strip conductor associated with the first part over the contact element to the strip conductor associated with the second part.

Pursuant to a further advantageous embodiment, in the actuating position the contact element connects a strip conductor associated with the first part in an electrically conductive manner with the second part. With this embodiment, the second parts serves to convey the control current back for the control of the furniture drive.

With the aforementioned embodiment, it is expedient that the second part form a common ground connection for the strip conductor of the first part. This embodiment has a particularly straightforward construction since separate strip conductors on the second part are, in principle, not required.

Pursuant to another advantageous further development, each strip conductor of the first part is associated with a contact element on the second part. With this embodiment, each strip conductor can serve as a part of a control line for the separated control of various functions of the furniture drive.

The first part and/or the second part expediently has at least one connection element for the connection of control lines of the furniture drive. In this way, connection of the control lines is simplified. The connection elements, can, for example, be embodied in the manner of a cable shoe, as terminal elements, or as soldering lugs.

The invention will be explained in greater detail subsequently with the aid of the accompanying drawings, in which an embodiment of an inventive hand switch for a furniture drive is illustrated.

Shown are:

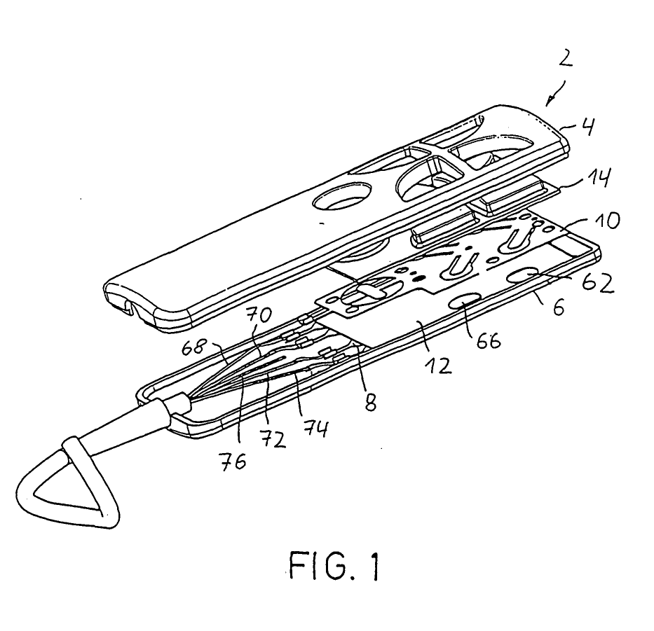

FIG. 1 in a schematic, perspective exploded view, a first embodiment of an inventive hand switch,

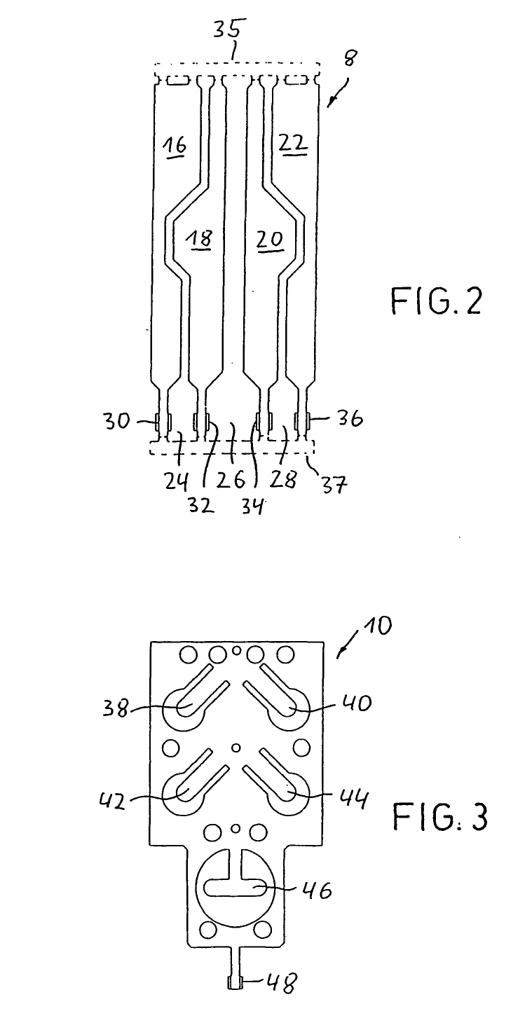

FIG. 2 a plan view, in an enlarged scale relative to FIG. 1, of a first part of the hand switch of FIG. 1, which first part has a plurality of strip conductors,

FIG. 3 in an illustration similar to FIG. 2, a second part of the hand switch of FIG. 1, which second part has a plurality of tongue-like contact elements,

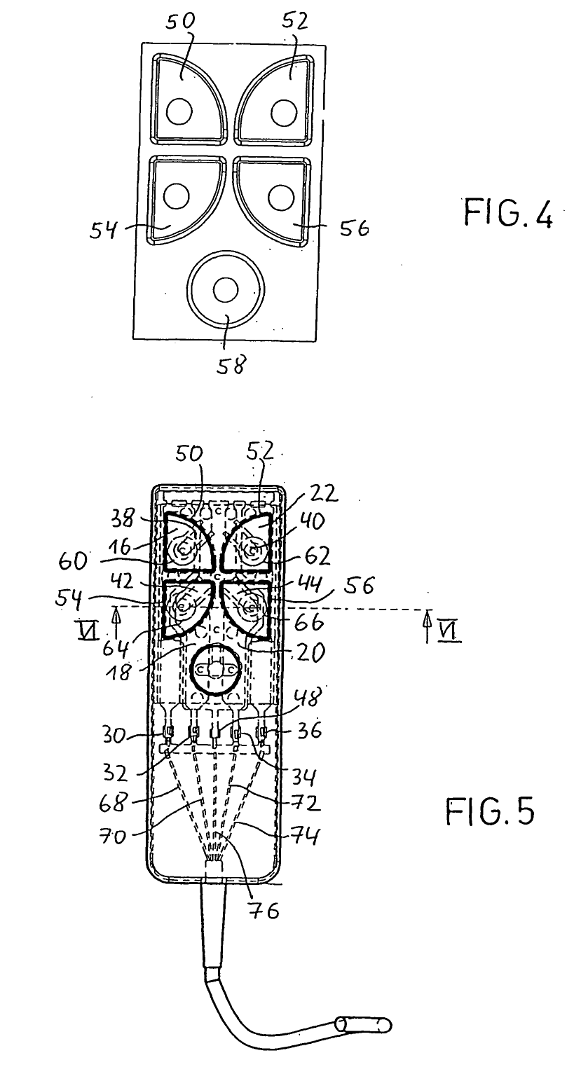

FIG. 4 in an illustration similar to FIG. 2, an actuating element of the hand switch of FIG. 1, which actuating element has a plurality of control knobs,

FIG. 5 a plan view of the hand switch of FIG. 1 in the assembled state, partially in phantom illustration,

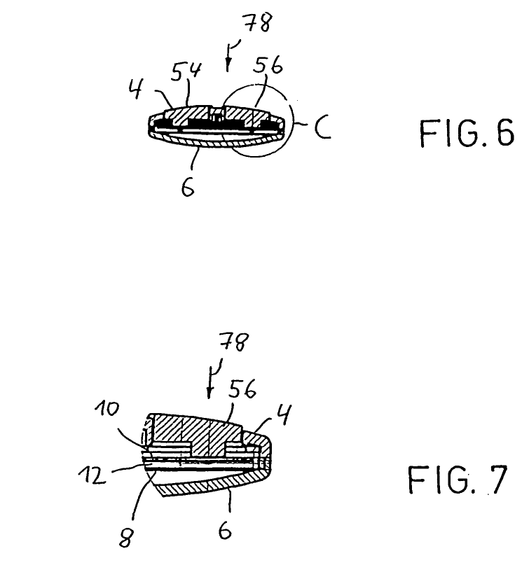

FIG. 6 a cross-sectional view taken along the line VI-VI in FIG. 5,

FIG. 7 a detail C from FIG. 6,

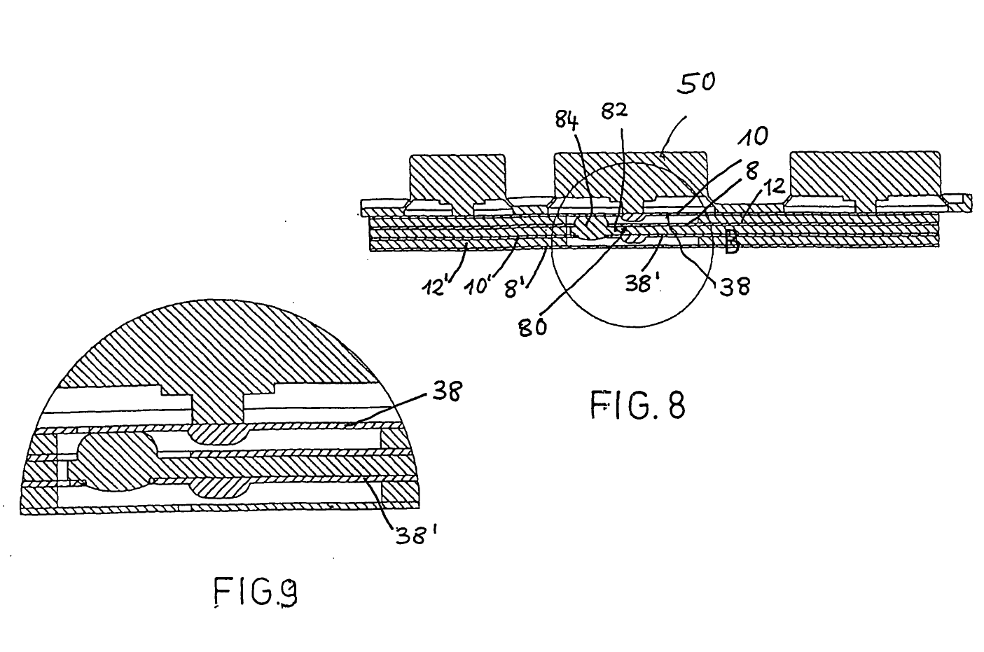

FIG. 8 a portion of a longitudinal cross-section through a second embodiment of a hand switch of an inventive furniture drive, whereby the contact elements are in the rest position,

FIG. 9 in an enlarged scale, a detail B from FIG. 8,

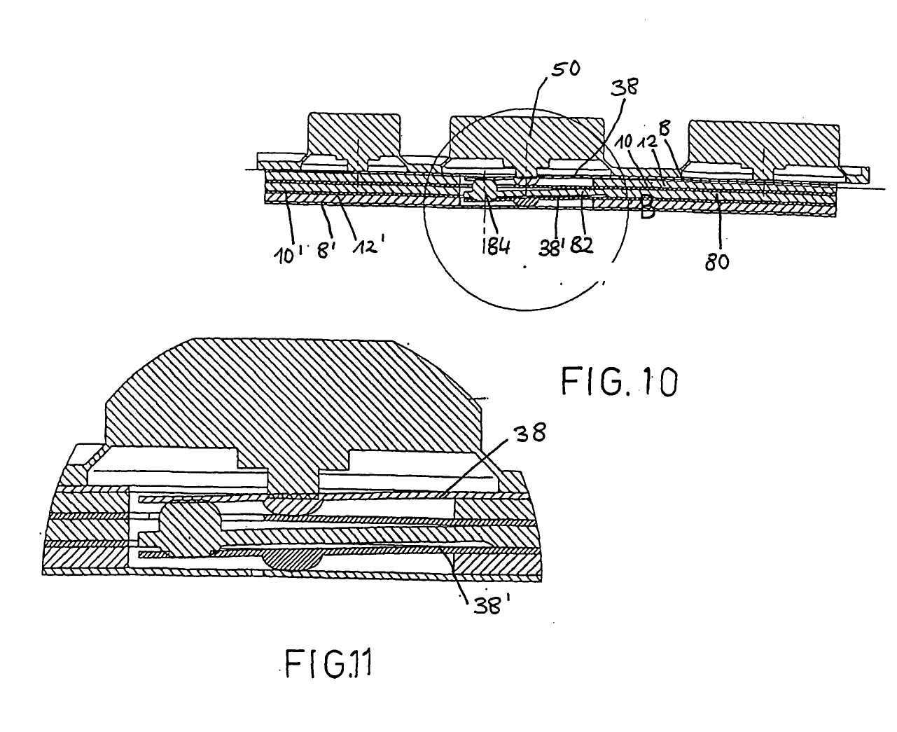

FIG. 10 in an illustration similar to FIG. 8, the embodiment of FIG. 8, whereby the contact elements are in the actuating position, and

FIG. 11 in an illustration similar to FIG. 9, a detail B from FIG. 10.

In FIG. 1, an embodiment of an inventive hand switch 2 is illustrated that is provided with a housing comprising half shells 4, 6 of plastic. The hand switch 2 is furthermore provided with a first part 8, which will be explained in greater detail below with the aid of FIG. 2, and a second part 10, which will be explained in greater detail below with the aid of FIG. 3. With this embodiment, the first part 8 and the second part 10 are embodied in the manner of a film or thin sheet, and are stamped from a thin sheet of phosphor bronze. In the assembled state of the hand switch 2, the first part 8 and the second part 10 are kept spaced apart by spacers, whereby with this embodiment the spacers are formed by a film or sheet-like third part 12, which is stamped out of a thin sheet of plastic.

The hand switch 2 furthermore has an actuating element 14, which in this embodiment has a mat-like configuration and is made of silicone. The actuating element 14 will be described in greater detail below with the aid of FIG. 4.

Illustrated in FIG. 2 is the first part 8, which in this embodiment has four conducting paths or strip conductors 16, 18, 20, 22 that are electrically insulated relative to one another and that by stamping out are separated from one another by spaces 24, 26, 28 and are electrically insulated relative to one another. For the connection of control lines, which are not illustrated in FIG. 2, for the control of the furniture drive, the strip conductors 16, 18, 20, 22 are provided with connection elements in the form of connection or terminal elements 30, 32, 34, 36. However, the connection elements can also be embodied in the manner of cable shoes or as soldering lugs for soldering on the control lines. Illustrated in FIG. 2 with dashed lines are crosspieces 35, 37 that interconnect the strip conductors 16, 18, 20, 22. In this way, the first part 8 can be delivered in a prefabricated manner, for example in the form of a roll, on which are successively wound a plurality of interconnected first parts 8. Since the crosspieces 35, 37 interconnect the strip conductors 16, 18, 20, 22 in an electrically conductive manner that is not desired for the assembly of the hand switch 2, the crosspieces 35, 37 are separated off during assembly of the first part 8. If necessary, after separating-off the crosspieces 35, 37, the strip conductors 16, 18, 20, 22 can be fixed in a spaced-apart state by any suitable means and can thereby be electrically insulated relative to one another in the event that this should be necessary. In principle, however, it is sufficient to loosely dispose the strip conductors 16, 18, 20, 22 next to one another during the assembly of the hand switch 2.

FIG. 3 illustrates a plan view of the second part 10, which has tongue-shaped, elastically deformable contact elements 38, 40, 42, 44, which are stamped out of the second part 10. For the connection of a control line, which is not illustrated in FIG. 3, for the control of the furniture drive, the second part 10 has a connection element in the form of a connection or terminal element 48.

FIG. 4 illustrates a plan view of the actuating element 14, which is provided with actuating or control knobs 50, 52, 56, 58.

FIG. 5 shows the components of the hand switch 2 in the installed state, in which the contact element 38 is disposed opposite the strip conductor 16, the contact element 40 is disposed opposite the strip conductor 22, the contact element 42 is disposed opposite the strip conductor 18 and the contact element 44 is disposed opposite the strip conductor 20.

In order upon actuation of the contact element 38 to enable an electrically conductive connection between the contact element 38 and the strip element 16, an opening 60 is formed in the third part 12 through which the contact element 38 extends in the actuating position, so that it contacts the strip conductor 16 of the first part 8. In a comparable manner, openings 62, 64, 66 are associated with the contact elements 40, 42, 44 respectively.

In the installed state, control lines 68, 70, 72, 74 are connected with the terminal elements 30, 32, 34, 36 respectively for the control of the furniture drive, and a control line 76 is connected with the terminal element 48 of the second part 10.

From FIG. 6, as well as FIG. 7, which shows a detail C in FIG. 6, it can be seen that in the installed state the parts 8, 10, 12 are disposed above one another in a sandwiched manner, whereby the control knobs 50, 52, 54, 56, which are manually operable in the direction of a part 78, rest against that side of the second part 10 that faces away from the first part 8, and that the components are surrounded by the half shells 4, 6 of the housing.

The hand switch 2 functions in the following manner:

When a user presses the control knob 50 down, the tongue-shaped contact element 28 is elastically deformed, so that it extends through the opening 60 in the third part 12 until it comes to rest against the strip conductor 16, so that an electrically conductive connection is established between the strip conductor 16 and the contact element 38, and hence between the strip conductor 16 and the second part 10. As a consequence, a control current flows over the control line 68, the contact element 38, the second part 10 and the control line 76 for the control of the furniture drive, for example for adjusting the incline of a lattice structure that is adjustable by means of the furniture drive. In a corresponding manner, other functions of the furniture drive can be controlled by the control knobs 52, 54, 56, 58.

Due to the sheet-like design of the parts 8, 10, 12, the hand switch 2 has an extremely low overall height. Since the parts 8, 10 can be produced by stamping out a thin metal sheet, and the part 12 can be produced by stamping out a thin plastic sheet, all in a particularly straightforward and hence economical manner, the hand switch 2 can on the whole be manufactured in a simple and cost effective manner.

The thickness of the third part 12 is such that in the position of rest of the control knobs 50-58, a contact of the respectively associated contact elements 38-46 with the strip conductors 16 to 22 associated therewith is prevented, yet in the actuating position of the control knobs 50-58 an electrically conductive contact is established.

FIG. 8 shows a second embodiment of a hand switch 2, which differs from the embodiment of FIG. 1 in that a further first part 8′, a further second part 10′ and a further third part 12′ are provided. The further first part 8′, the further second part 10′ and the further third part 12′ are embodied in the manner described above in connection with the parts 8 or 10 or 12. The further second part 10′ is disposed below the first part 8, whereby a spacer 80 is disposed between the two parts.

The further second part 10′ has a further contact element 38′, which in an actuating position illustrated in FIG. 10 contacts a strip conductor formed on the further first part 8′, and thus closes a further control circuit for the control of the furniture drive. The further control circuit serves, in this embodiment, for the activation or deactivation of a power clearing means, which in the rest position of the further contact element 38′ (see FIG. 8) is activated, so that the entire furniture drive is without power. In contrast, in the actuating position of the further contact element 38′, the power clearing means is deactivated.

The spacer 80 has a single arm lever 82 that is disposed between the first contact element 38 and the further contact element 38′, and that during a movement of the first contact element 38 into the actuating position moves the further first contact element 38′ into the actuating position. For this purpose, the single arm lever 82 is provided at its free end with a widened portion 84, the expansion of which in a direction perpendicular to the contact elements 38, 38′ is such that when the control knob 50 is pressed down, first the further control circuit is closed by the further contact element 38′ and the power clearing means is deactivated, and then subsequently the control circuit is closed by the contact element 38.

In this way, when the control knob 50 is released, the power clearing means is automatically activated, so that when the furniture drive is not being used, it is always without power.

1. Electromotive furniture drive for the adjustment of parts of a piece of furniture relative to one another,
with a hand switch on which or in which are disposed electrical switching means for the control of the furniture drive,
characterized in that,
the electrical switching means is provided with at least one first part (8), which has at least one strip conductor (16) that is part of a control circuit for the control of the furniture drive, and at least one second part (10), whereby the first part (8) and the second part (10) are spaced from one another in a rest position, and
whereby the second part (10) has at least one elastically deformable contact element (38) that is comprised at least partially of an electrically conductive material and is movable between the rest position and an actuating position in which an electrical contact is established between the at least one strip conductor (16) and the contact element (38) in such a way that in the actuating position a control of the furniture drive is effected.

2. Furniture drive according to claim 1, characterized in that, the contact element (38) has a tongue-like configuration.

3. Furniture drive according to claim 2, characterized in that, the contact element (38) is monolithically formed with the second part (10).

4. Furniture drive according to claim 1, characterized in that, the first part (8) and/or the second part (10) has an essentially sheet-like or laminar configuration.

5. Furniture drive according to claim 1, characterized in that, the first part (8) and/or the second part (10) is comprised essentially entirely of an electrically conductive material, especially metal.

6. Furniture drive according to claim 1, characterized in that, the first part (8) and/or the second part (10) has an essentially sheet-like configuration.

7. Furniture drive according to claim 1, characterized in that, the first part (8) and the second part (10) are held spaced apart by spacer means.

8. Furniture drive according to claim 7, characterized in that, the spacer means is comprised of an electrically insulating material, especially plastic.

9. Furniture drive according to claim 7, characterized in that, the spacer means is formed by an essentially laminar third part (12) that has at least one opening (60) through which in the actuating position extends the contact element (38) for contacting the strip conductor of the first part (8).

10. Furniture drive according to claim 1, characterized in that, the second part (10) has at least two contact elements (38-46).

11. Furniture drive according to claim 9 and 10, characterized in that, a respective opening in the third part (12) is associated with the contact elements (38-46).

12. Furniture drive according to claim 1, characterized in that, the first part (8) and/or the second part (10) is formed by a stamped part.

13. Furniture drive according to claim 1, characterized in that, the first part (8) and/or the second part (10) is comprised of phosphor bronze.

14. Furniture drive according to claim 1, characterized in that, the first part (8) has at least two strip conductors (16-22) that are electrically insulated relative to one another.

15. Furniture drive according to claim 14, characterized in that, in the actuating position the contact element interconnects two strip conductors associated with the first part (8) in an electrically conductive manner.

16. Furniture drive according to claim 1, characterized in that, in the actuating position the contact element connects a strip conductor associated with the first part (8) with a strip conductor that is associated with the second part (10), and that is connected with the contact element in an electrically conductive manner, in an electrically conductive manner.

17. Furniture drive according to claim 15, characterized in that, in the actuating position the contact element (38) connects a strip conductor (16) associated with the first part (8) in an electrically conductive manner with the second part (10).

18. Furniture drive according to claim 17, characterized in that, the second part (10) forms a common ground connection for the strip conductors (16-22) of the first part (8).

19. Furniture drive according to claim 14, characterized in that, a contact element on the second part (10) is associated with each strip conductor (16-22) of the first part (8).

20. Furniture drive according to claim 1, characterized in that, the first part (8) and/or the second part (10) has at least one connection element for the connection of control lines (68-76) of the furniture drive.

21. Furniture drive according to claim 1, characterized in that, the electrical switching means have a further first part (8′) and a further second part (10′) with a further electrically deformable contact element (38′) that is at least partially comprised of an electrically conductive material and is movable between a rest position and an actuating position in which an electrical contact is established between a strip conductor of the further first part (8′) and the further contact element (38′) and a further control circuit is closed for the control of the furniture drive.

22. Furniture drive according to claim 2, characterized in that, the further control circuit serves for the activation or deactivation of a power clearing means of the furniture drive.
